(19) United States
(12) Patent Application Publication
(10) Pub. No.: US 2019/0139457 A1
(43) Pub. Date: May 9, 2019

(54) Label, Device, System and method for sorting bolts

(71) Applicant: SOLUTION 3D PLUS INC., Quebec (CA)

(72) Inventor: Michel Cournoyer, Quebec (CA)

(21) Appl. No.: 16/129,344

(22) Filed: Sep. 12, 2018

Related U.S. Application Data
(63) Continuation-in-part of application No. 15/631,863, filed on Jun. 23, 2017, now abandoned.

(30) Foreign Application Priority Data
Jul. 5, 2016 (GB) 1611742.6

(51) Int. Cl. G09F 3/02; F16B 1/00

(52) U.S. Cl. CPC G09F 3/02; F16B 1/0071; G09F 2003/0272; G09F 2003/0216; G09F 2003/0214

(57) ABSTRACT

The present invention relates to label, device, system and method for sorting bolts, bars, pins, studs, dowels, screws or the like (collectively and individually described herein as a bolt). The bolts are being characterized by a first and a second dimension. The identification system comprises a color chart defining all ten numerals and most commonly used bolt diameters corresponding to various colors and an identification label. The identification label comprises a main section and at least one other section being both adapted to receive at least one color and/or a numeral. Each combination of a color and a numeral being defined by the color chart. The combination of colors and/or numerals of the main section defines the first dimension of the bolt and the combination of colors and/or numerals of the at least one other section defines the second dimension of the bolt.

### CROSS-REFERENCE TO RELATED APPLICATIONS

The present patent application claims the benefits of priority of GB Patent Application No. 1611742.6, entitled “Color and shape code for sorting bolts”, and filed at the Great Britain Patent Office on Jul. 5, 2016 and is a continuation-in-part of U.S. application Ser. No. 15/631,863 filed on Jun. 23, 2017.

### FIELD OF THE INVENTION

The present invention generally relates to classification and identification systems. More particularly, the present invention relates to a label, device, system and method for sorting bolts, bars, pins, studs, dowels, screws or the like (collectively and individually described herein as a bolt) depending on their characteristic dimensions, such as length and diameter, in order to facilitate distant bolts identification.

### BACKGROUND OF THE INVENTION

Classification and identification of work tools is considered as one of the major factors influencing the operating time and costs on worksites. Usually, tool identification may require additional displacement, research and even measurement efforts from the operators to correctly choose the needed tools. Similarly, the identification of bolts, bars, pins, studs, dowels, screws or the like (collectively and individually described herein as a bolt) may, sometimes, be visually difficult or even impossible when being installed on worksites.

Conventionally, the size of each hand tool used to be stamped into the outer surface of the hand tool in order to help the user to properly identify and choose the needed tool. However, while performing in environment in which grease, oil and dust may easily soil the surface of the tool, the stamped size information may be easily obscured.

Nowadays, classification methods and systems, such as the color code tool identification method disclosed in the U.S. Pat. No. 4,841,653 and the identification system disclosed in the U.S. Pat. No. 6,082,227, have been proposed to sort and to classify tools, such as hand tools or cutting tools. These methods and systems provide, specifically, color bands to allow marking the work tools depending of their sizes. However, such systems are not essentially accommodated to be used at worksites with bolts which, once being in use or installed in devices, machines or structures, do not necessary keep their initial surface texture and become sometimes non-visible to the user.

Furthermore, some visual coding systems, such as the system disclosed in the U.S. Pat. No. 4,982,627, have provided a color chart to assist in the determination of the size of various hand tools. Such coding systems require the existence of at least one groove formed on the surface of the tool in order to receive the colored materiel and to form both together a color ring indicating a size numeral. Such systems are considered inconvenient as they require, minimally, machining the tool surface which not only presents additional costs but also may lead to tool's deterioration.

U.S. Pat. No. 8,739,444 (Poole) describes a ‘Color coding system for sizing fastener parts, tools and storage bins’ to assist in identifying and matching the cooperating diameters of fasteners, parts and tools by using color code markings on the various sizes of tools and fastener parts. The coding system disclosed color codes markings which are disposed on the front surface of a storage bin. It does not describe or use a chart but rather a bolt gauge (col. 4, line 66) and it does not show the use of both a color and a number for each of the length and the diameter of the bolt.

According to Poole the storage comprises a plurality of compartments for holding fasteners parts according to their size (diameter). This system does not take in account the world of big components which can weigh many tons and does not provide for the identification of a structural bolt container from a distance. Poole does not cover the same range of possibilities according to the reality of the structural construction industries.

For example, in the structural construction industry, the bolt lengths go from 1½ inch to more than 20 inches in length. Such a range requires a better system to identify all the possibilities in one chart which is practical and understandable by everybody on the construction site.

Despite the previous use of different tool identification systems, there is still a need to provide a color code system allowing an easy distant identification of bolts when being simply stored, shipped from the manufacturer to the user or installed on worksites.

### SUMMARY OF THE INVENTION

The shortcomings of the prior art are generally mitigated by providing color and shape code label, device, system and method for sorting bolts, bars, pins, studs, dowels, screws or the like (collectively and individually described herein as a bolt).

In one aspect of the invention, the present system aims at optimizing the operating time and at reducing costs on worksites by allowing a distant visual identification of the needed or the already installed bolts which reduces additional research and measurement efforts of the operators.

The present invention is directed to a system for sorting bolts, bars, pins, studs, dowels, screws or the like (collectively and individually herein described herein as a bolt), the bolts being characterized by a first and a second dimension, wherein each of the most commonly used first dimension of said bolts is associated to a numeral and/or to a selected color and wherein each of the most commonly used second dimension of said bolts is associated to a numeral and/or to a selected color, the system comprising an identification label comprising a main section adapted to receive at least one color and/or a numeral which is associated with said first dimension and at least a first other section adapted to receive at least one color and/or a numeral which is associated with said second dimension.

In another aspect of the invention, the identification label comprises at least a second other section adapted to receive at least one color and/or a numeral when the said dimensions are identified using the imperial measurement system. Each combination of a color and a numeral is pre-defined by a chart; wherein a combination of colors and/or numerals of the main section defines the first dimension of the bolt; and wherein a combination of colors and/or numerals of the first other section and of the second other section defines together the second dimension of the bolt.

In another aspect of the invention, the said label is adapted to be attached to any containers containing the bolts and/or to structures on a worksite where the bolts are destined to be installed. The said label is adapted to allow a distant identification of bolts required to be installed to a corresponding labeled structure on a worksite. The said label is adapted to allow a distant identification of the containers in which the bolts are stored. The identification label further comprises a further symbol indicating the type of bolt.

The present invention is further directed to an identification label for identifying bolts, bars, pins, studs, dowels, screws or the like (collectively and individually described herein as a bolt), the bolts being characterized by a first and a second dimension, the identification label comprising a main section adapted to receive at least one color and/or a numeral associated to said first dimension and at least a first other section adapted to receive at least one color and/or a numeral associated to said second dimension.

In another aspect of the invention, the identification label further comprises at least a second other section adapted to receive at least one color and/or a numeral when said dimensions use the imperial measurement system. Each combination of a color and a numeral is defined by a color chart; wherein a combination of colors and/or numerals of the main section defines the first dimension of the bolt; and wherein a combination of colors and/or numerals of the at least first and second other sections defines together the second dimension of the bolt.

In yet another aspect of the invention, the identification label is being adapted to be attached to the bolts containers and/or to structures on worksite to which said bolts are to be installed. The said label is adapted to allow a distant identification of the bolts required to be installed to a corresponding labeled structure on a worksite. The identification label is being adapted to allow a distant identification of containers containing the bolts. The identification label further comprises a letter indicating a type of bolt.

The present invention is further directed to a method for identifying and sorting bolts, bars, pins, studs, dowels, screws or the like (collectively and individually described herein as a bolt) having a first dimension and a second dimension, the method comprises creating a chart wherein each of the most commonly used first dimension of said bolts is associated to a numeral and/or to a selected color and wherein each of the most commonly used second dimension of said bolts is associated to a numeral and/or to a selected color; providing an identification label comprising a main section and at least a first other section; associating the main section with said first dimension and with at least one of said associated color and/or one said associated numeral; and associating the at least first other section with said second dimension and with at least one said color and/or one said numeral; wherein each combination of a color and a numeral is selected from the color chart.

In another aspect of the invention, the color and/or numeral associated with said main section corresponds to the length of the bolt and the color and/or numeral associated with said first other section corresponds to the diameter of the bolt.

In yet another aspect of the invention, wherein the imperial measurement system is used, the method further comprises a second other section, wherein the combination of colors and/or numerals associated with first other section and the second other section together correspond to the second dimension of the bolt.

In yet another aspect of the invention, the method further comprises reading from left to right the colors and/or numerals of the main section to verify the first dimension of the bolt; reading from left to right the colors and/or numerals of the at least one first other section taken alone or in combination with the at least one second section to verify the second dimension of the bolt depending on using either the imperial measurement system or the metric measurement system. The method further comprises attaching identification labels to containers of corresponding bolts and/or to corresponding support structures on each worksite allowing a distant identification of the bolts.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 illustrates a first embodiment of a color chart corresponding to all ten basic numerals and most commonly used fractions in the imperial measurement system in accordance with the principles of the present invention.

FIG. 2 illustrates a second embodiment of a color chart corresponding to most commonly used diameters in the imperial measurement system in accordance with the principles of the present invention.

FIG. 3 illustrates a preferred embodiment of an identification label used with the imperial measurement system in accordance with the principles of the present invention.

FIG. 4 illustrates a preferred embodiment of an identification label used with the metric measurement system in accordance with the principles of the present invention.

FIGS. 5A-5D illustrate examples of identification labels used with the imperial measurement system in accordance with the principles of the present invention.

FIG. 6A-6D illustrate examples of identification labels used with the metric measurement system in accordance with the principles of the present invention.

FIG. 7 illustrates a third embodiment of a color chart corresponding to rarely used fractions in the imperial measurement system in accordance with the principles of the present invention.

FIG. 8 illustrate an example of support structures wherein the identification labels are used to show the bolt type to use in the appropriate zones.

FIG. 9 illustrate a circular container wherein 4 identification labels are used on the body of the circular container.

FIG. 10 illustrate a circular container wherein an identification label is used on the top of the circular container.

FIG. 11 illustrated a box wherein 4 identification labels are used on the 4 laterals side of the box.

FIG. 12 illustrate a box wherein an identification label is used on the top of the box.

FIG. 13 illustrates an example of an identification label for a bolt with an hexagonal head in accordance with the invention.

FIG. 14 illustrates an example of an identification label for a bolt with a round head in accordance with the invention.

FIG. 15 illustrates examples of identification labels used to distinguish between different types of bolts.

FIGS. 16A, 16B and 16C illustrate examples of identification labels used to identify the location of washers.

### DETAILED DESCRIPTION OF THE PREFERRED EMBODIMENT

A novel Color and shape code label, device, system and method for sorting bolts will be described hereinafter. Although the invention is described in terms of specific illustrative embodiments, it is to be understood that the embodiments described herein are by way of example only and that the scope of the invention is not intended to be limited thereby.

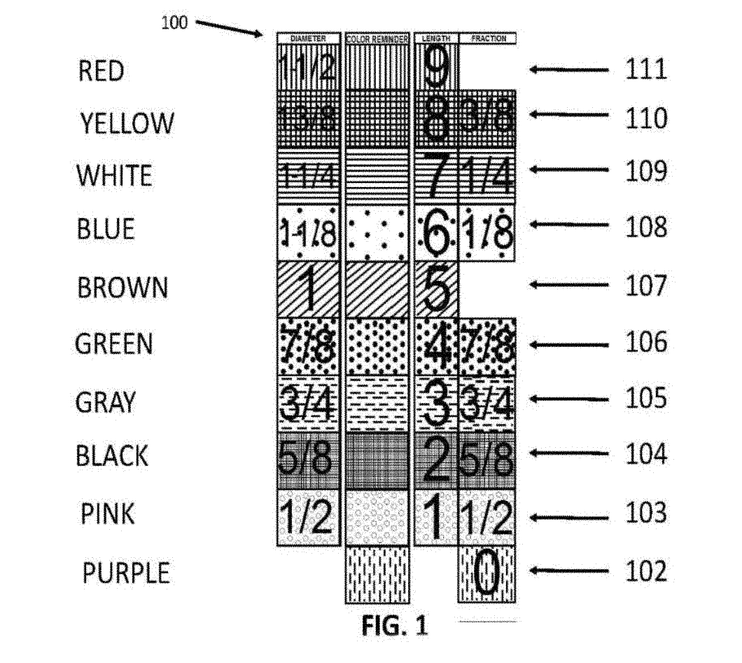

Referring to FIG. 1, a first embodiment of a color chart 100 corresponding to all ten basic numerals and most commonly used fractions in the imperial measurement system is illustrated. This chart color 100 allows, essentially, to classify and sort bolt based on their characteristic diameter and length.

Going from bottom to top of the color chart 100, any color sequence may be used. For example, the purple color 102, may be symbolizing a temperature of zero kelvin or any other easy to remember element or concept, corresponds to the numeral zero. The pink color 103, symbolizing a pink candy or any other easy to remember element or concept, may correspond to the numeral one when identifying a length and to the fraction ½ when identifying either a diameter or a fractional length as commonly used in the imperial measurement system. The black color 104, symbolizing asphalt or any other easy to remember element or concept, may correspond to numeral two when identifying a length and to the fraction ⅝ when identifying either a diameter or a fractional length as commonly used in the imperial measurement system. The gray color 105, symbolizing a pavement or any other easy to remember element or concept, may correspond to the numeral three when identifying a length and to the fraction ¾ when identifying either a diameter or a fractional length as commonly used in the imperial measurement system. The green color 106, symbolizing the earth surface or any other easy to remember element or concept, may correspond to the numeral four when identifying a length and to the fraction ⅞ when identifying either a diameter or a fractional length as commonly used in the imperial measurement system. The brown color 107, symbolizing a tree trunk or any other easy to remember element or concept, may correspond to the numeral five when identifying a length and to the numeral one when identifying a diameter as commonly used in the imperial measurement system. The blue color 108, symbolizing the sky or any other easy to remember element or concept, may correspond to the numeral six when identifying a length and to the fractional numeral 1⅛ when identifying a diameter as commonly used in the imperial measurement system. The white color 109, symbolizing the clouds or any other easy to remember element or concept, may correspond to the numeral seven when identifying a length and the fractional numeral 1¼ when identifying a diameter as commonly used in the imperial measurement system. The yellow color 110, symbolizing the sun or any other easy to remember element or concept, may correspond to the numeral eight when identifying a length and to the fractional numeral 1⅜ when identifying a diameter as commonly used in the imperial measurement system. The red color 111, symbolizing high temperatures such as 100° C. or any other easy to remember element or concept, may correspond to the numeral nine when identifying a length and to the fractional numeral 1½ when identifying a diameter as commonly used in the imperial measurement system.

Understandably, the color chart 100 is equally adapted to be used for both metric and imperial measurement systems.

Understandably, the color chart 100 would typically be attached to the bolts' containers in the store of a manufacturer, a shipper or a user. The color chart 100 would typically further be indicated in at least one commonly accessible place in each worksite.

Understandably, the main goal of establishing a correlation between colors, numerals and concrete symbols is to facilitate the memorization of the size signification of each color.

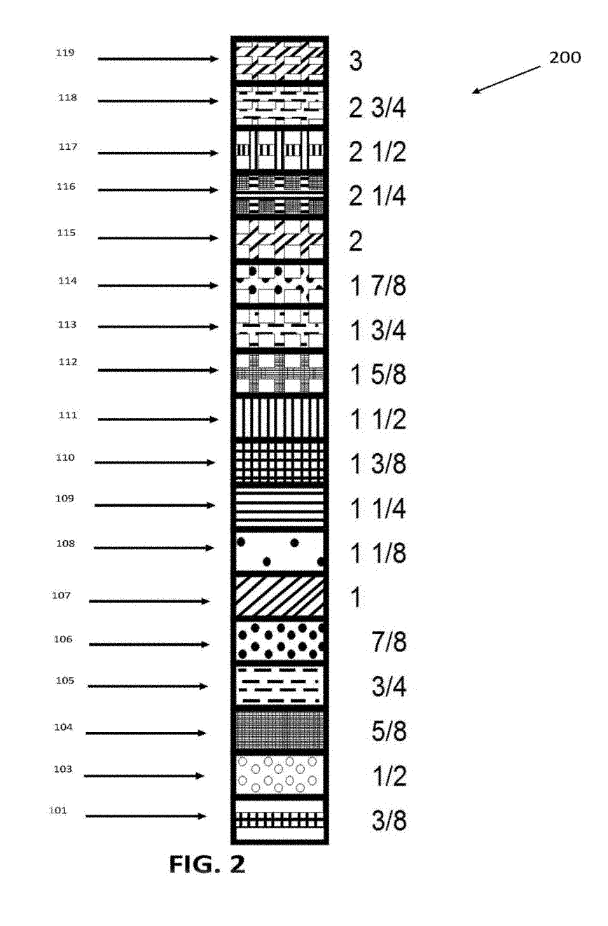

Referring now to FIG. 2, a second embodiment of a color chart 200 corresponding to most commonly used diameters in the imperial measurement system is illustrated. Additionally, to all previous colors and diameters correspondence shown in FIG. 1, FIG. 2 provides the color presentation for less commonly used diameters in the imperial measurement system. The white box comprising a central yellow band 101 corresponds to the fractional numeral ⅜ when identifying a diameter as commonly used in the imperial measurement system. The white box comprising two vertical black lines crossing a horizontal black line 112 corresponds to the fractional numeral 1⅝ when identifying a diameter as commonly used in the imperial measurement system. The white box comprising two vertical gray lines crossing a horizontal gray line 113 corresponds to the fractional numeral 1¾ when identifying a diameter as commonly used in the imperial measurement system. The white box comprising two vertical green lines crossing a horizontal green line 114 corresponds to the fractional numeral 1⅞ when identifying a diameter as commonly used in the imperial measurement system. The white box comprising two vertical brown lines crossing a horizontal brown line 115 corresponds to the numeral 2 when identifying a diameter as commonly used in the imperial measurement system. The black box comprising two vertical white lines crossing a horizontal white line 116 corresponds to the fractional numeral 2¼ when identifying a diameter as commonly used in the imperial measurement system. The white box comprising two vertical red lines crossing a horizontal red line 117 corresponds to the fractional numeral 2½ when identifying a diameter as commonly used in the imperial measurement system. The white box comprising two vertical gray lines crossing two horizontal gray lines 118 corresponds to the fractional numeral 2¾ when identifying a diameter as commonly used in the imperial measurement system. The white box comprising two vertical brown lines crossing two horizontal brown lines 119 corresponds to the numeral 3 when identifying a diameter as commonly used in the imperial measurement system.

Understandably, the color chart 200 could be attached, next to the color chart 100, to the bolts' containers in the store of a manufacturer, a shipper or a user. The color chart 200 would typically further be indicated in at least one commonly accessible place in each worksite.

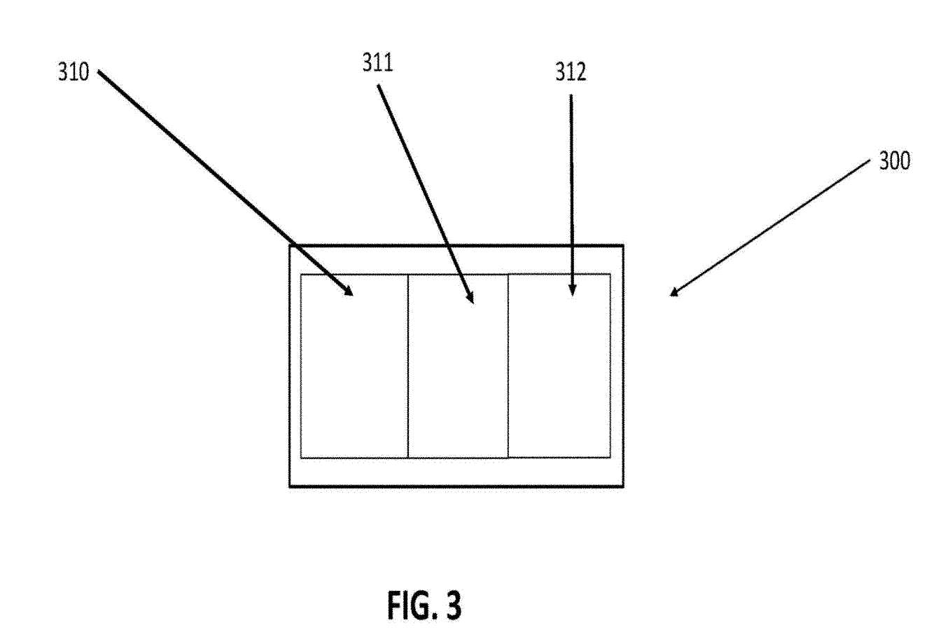

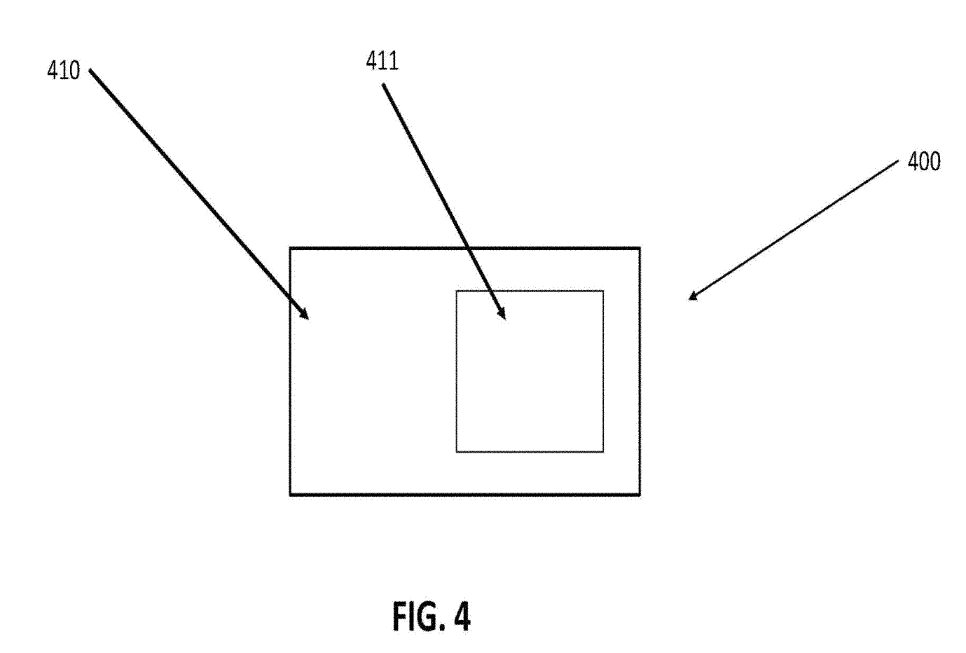

Referring now to FIGS. 3 and 4, some preferred embodiments of an identification labels 300 and 400 used, respectively, with the imperial and the metric measurement systems are illustrated. Each label 300 or 400 is adapted to be attached to the corresponding bolt container in the store of a manufacturer, a shipper or a user in order to properly classify and store bolts. Each label 300 or 400 is further adapted to be attached on each support structure of each worksite comprising the corresponding bolts. Such labels 300 or 400 allows a manufacturer to easily sort and identify the bolts once being fabricated, allows the shipper to easily classify the bolts during the delivery process and especially allows operators to easily identify and choose the needed bolts to be installed and to easily find out which bolt is to be installed where in each structure of a worksite.

In a preferred embodiment, each label 300 or 400 comprises a main section 310 or 410 adapted to receive at least one background color or a numeral and preferably both. Each main section 310 or 410 is adapted to comprise at least a first section 311 or 411 adapted to receive at least one color or a numeral and preferably both. For the imperial identification labels 300, the main section 310 may further comprise a second section 312 adapted to receive at least one color or a numeral and preferably both.

For both imperial and metric measurements' systems, the background color or numeral of the main section 310 or 410 indicates the basic bolt diameter.

For the metric measurement system, the at least one color or the numeral of the at least one first section 411 indicates the characteristic length of the bolt in millimeters. (See FIG. 4)

For the imperial measurement system, the at least one color or the numeral of the at least one first section 311 indicates the integer part of the characteristic length of the bolt in inch. (See FIG. 3)

For the imperial measurement system, the at least one color or the numeral of the at least one second section 312 indicates the decimal part of the characteristic length of the bolt in inch. (See FIG. 3)

The color and shape identification allows either an easy distant bolts identification or an easy bolt location identification.

Understandably, in another embodiment each section of each label 300 or 400 may comprise just a number or a color.

Understandably, each of the main sections 310 or 410, of the at least one first sections 311 or 411 and the at least one second section 412, may comprise a combination of different colors. In such a case, the colors should be read from left to right.

Understandably, the principle unit of all numerals figuring on the identification label 300 is the inch.

Understandably, the basic unit of all numerals figuring on the metric identification label 400 is the millimeter.

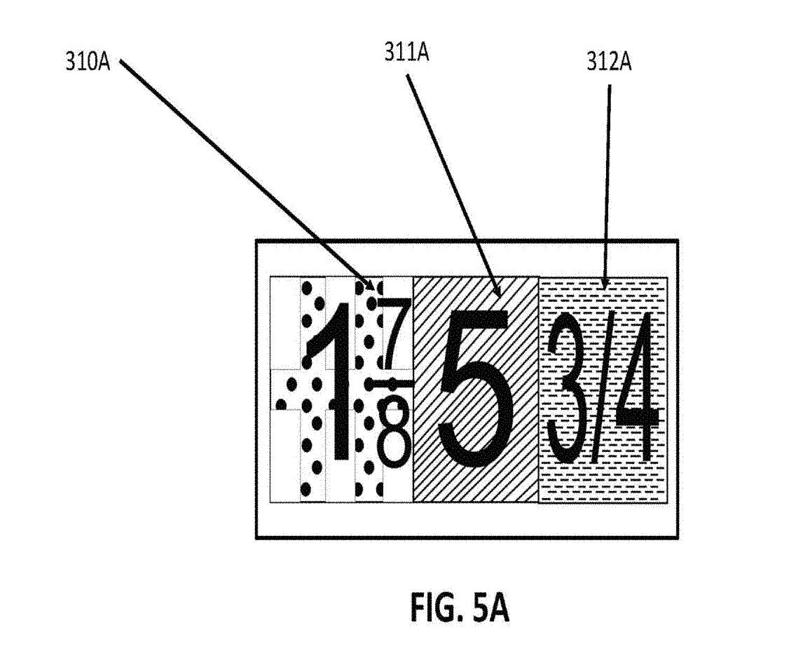

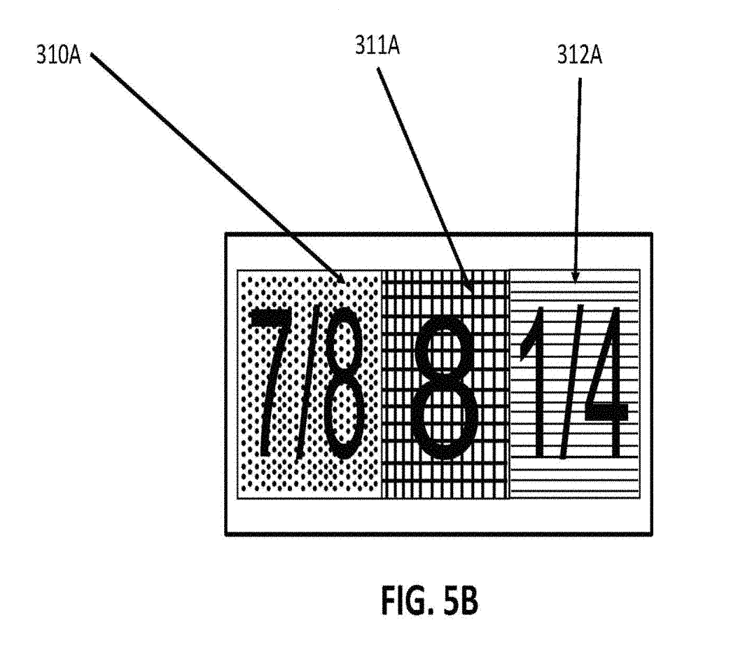

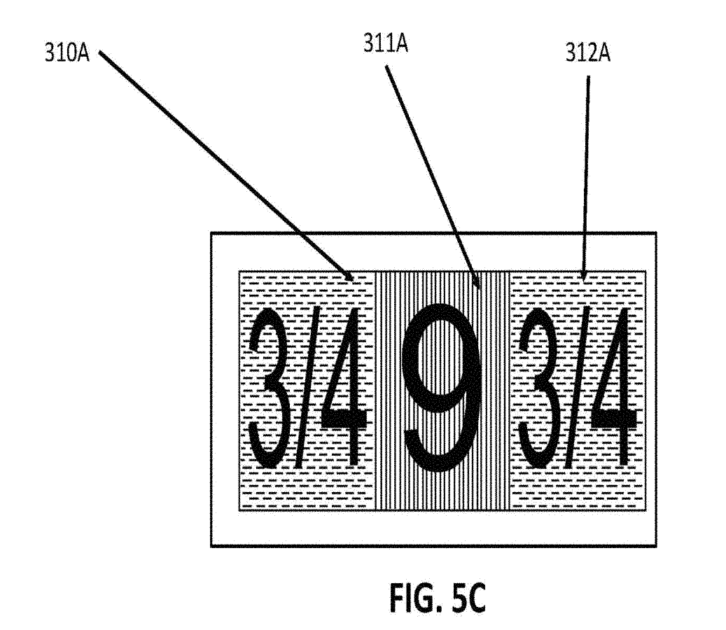

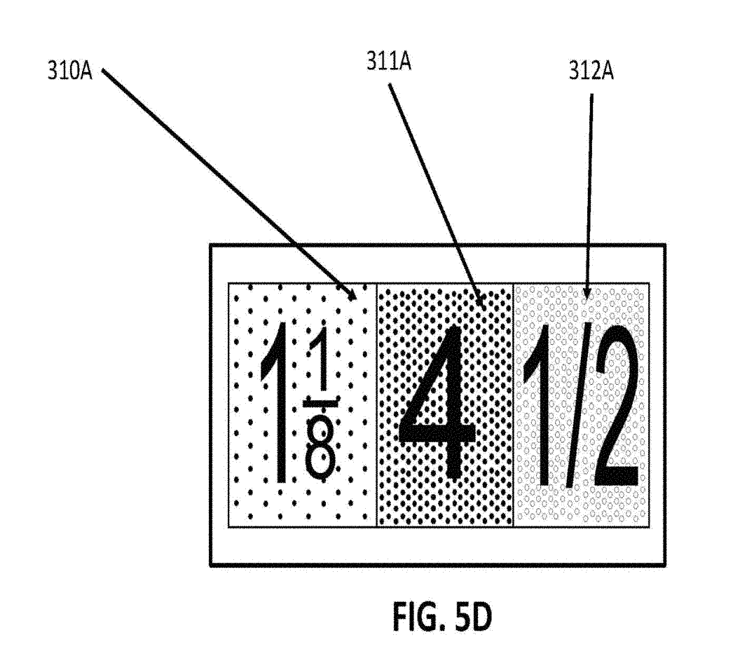

Referring to FIGS. 5A-5D, some examples of identification labels used with the imperial measurement system are illustrated. As shown on FIG. 5A, the main section 310A comprises a white background comprising two vertical green lines crossing one horizontal green line indicating, thus, a diameter of 1⅞″ (See FIG. 2). The main section 310A comprises a first section 311A and a second section 312A identifying both together a decimal numeral indicating the characteristic length of the bolt in inches. The first section 311A being characterized by a brown color identifying an integer part 5 (See FIG. 1) and the second section 312A being characterized by a gray color identifying a decimal part ¾ (See FIGS. 1 and 2). Thus the identification label of FIG. 5A is directed to identify a bolt of a diameter ø1⅞″ and a length of 5¾″.

According to the same principles, FIGS. 5B-5D are directed to identify, respectively, a bolt of a diameter ø⅞″ and a length of 8¼″, a bolt of a diameter ø¾″ and a length of 9¾″ and a bolt of a diameter ø1⅛″ and a length of 4½″.

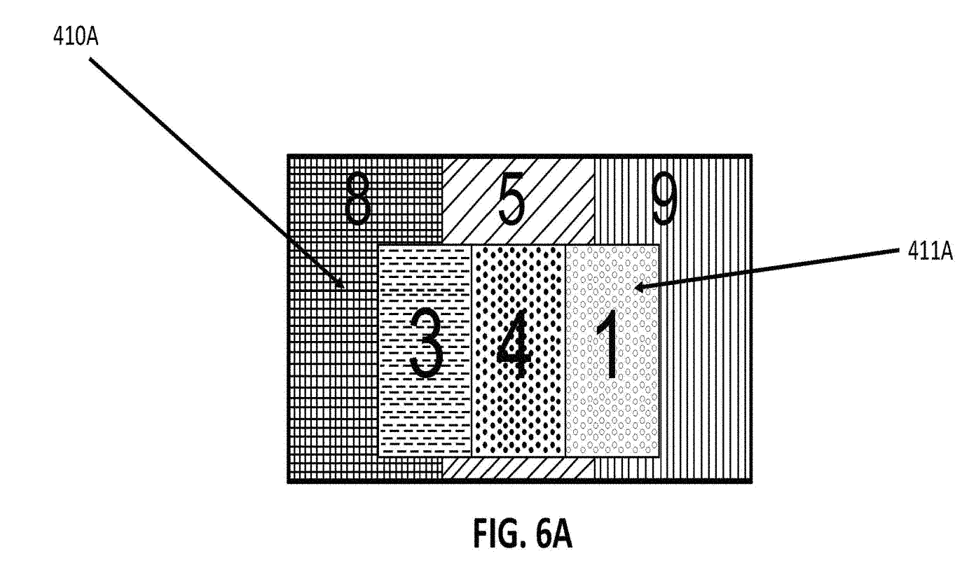

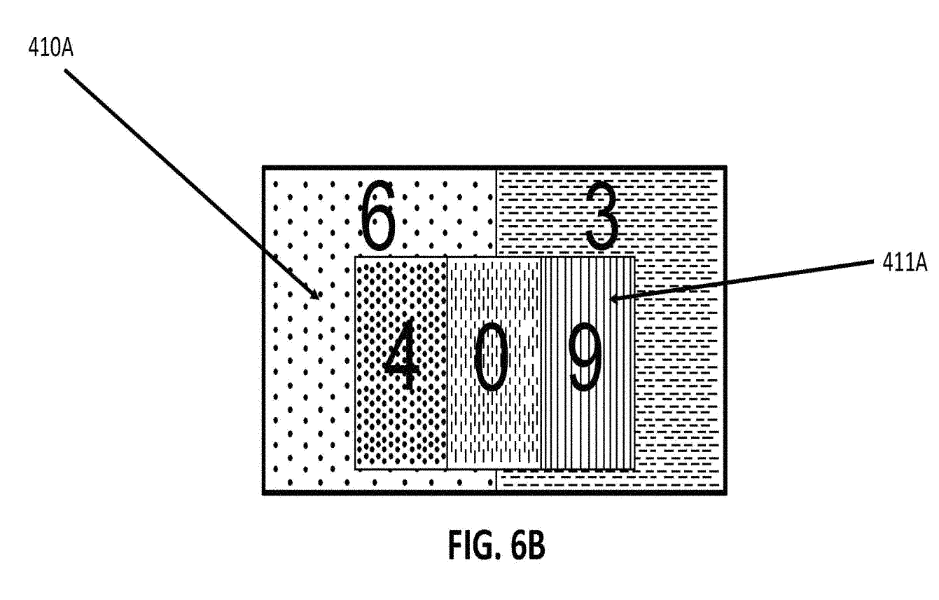

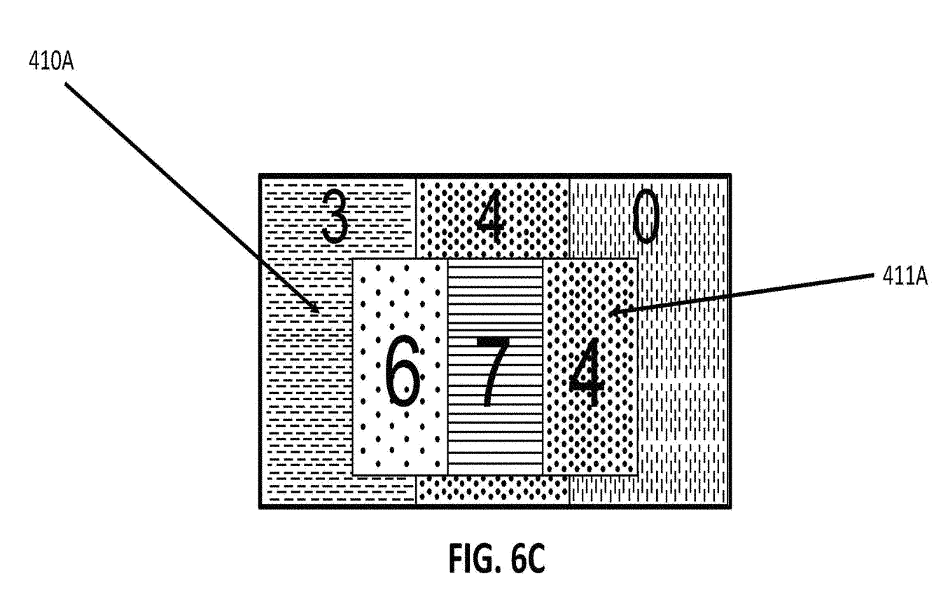

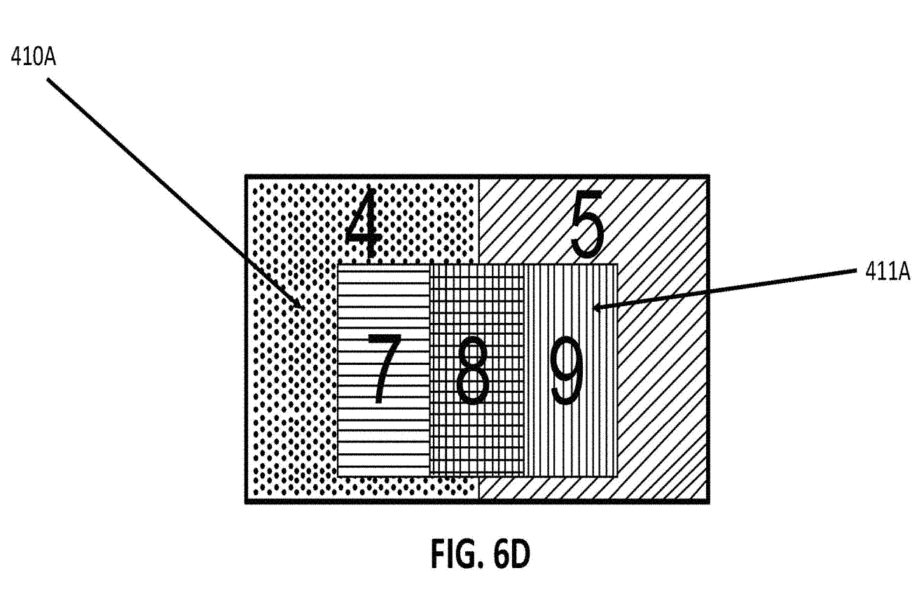

Referring now to FIGS. 6A-6D, some examples of identification labels used with the metric measurement system are illustrated. As shown on FIG. 6A, the main section 410A comprises a multicolor background comprising first: the yellow color, second: the brown color and third: the red color indicating, thus, a diameter of 859 millimeters (See FIG. 1). The main section 410A comprises a first section 411A being multicolored and comprising first: the gray color, second: the green color and third: the pink color indicating, thus a length of 341 millimeters. Thus, the identification label of FIG. 6A is directed to identify a bolt of a diameter ø859 millimeters and a length of 341 millimeters.

According to the same principles, FIGS. 6B-6D are directed to identify, respectively, a bolt of a diameter ø63 millimeters and a length of 409 millimeters, a bolt of a diameter ø340 millimeters and a length of 674 millimeters and a bolt of a diameter ø45 millimeters and a length of 789 millimeters.

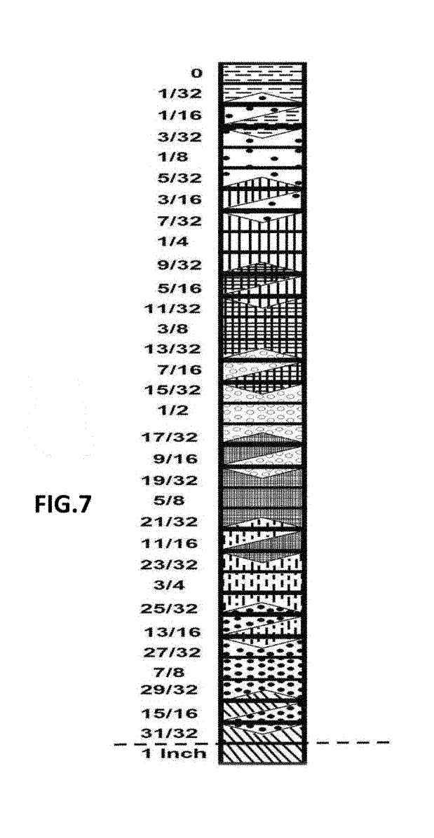

Referring now to FIG. 7, a color chart corresponding to rarely used fractions in the imperial measurement system is illustrated. Additionally to all previous fractional sizes introduced in FIGS. 1 and 2, the most important fractions to retain in FIG. 7 are ⅛, ¼ and ⅜.

The white box comprising a central horizontal blue band 120 corresponds to the fractional numeral ⅛ when identifying a diameter or a fractional length as commonly used in the imperial measurement system. The black box comprising a central horizontal white band 121 corresponds to the fractional numeral ¼ when identifying a diameter or a fractional length as commonly used in the imperial measurement system. The white box comprising a central horizontal yellow band 122 corresponds to the fractional numeral ⅜ when identifying a diameter or a fractional length as commonly used in the imperial measurement system.

Referring now to FIGS. 1 to 7, a method for classifying and sorting bolts is illustrated. The method comprises first identifying the characteristic dimensions of the bolts, such as diameter and length of bolts to be marked, then providing an identification label comprising at least one main section and at least one other section in the case of the imperial measurement system or more in the case of the metric measurement system. The method further comprises providing the main section with at least one background color or one numeral and preferably both and providing the at least one other section with at least one color or one numeral and preferably both.

In the case of the imperial measurement system, the method may further comprise providing an initial identification label comprising at least one main section, which comprises at least one first other section and at least one second other section. The method may further comprise providing the main section with at least one background color or one numeral and preferably both, providing the at least first other section with at least one color or one integer part of a numeral and preferably both and providing the at least second other section with at least one color or one fractional part representing the decimal part of the numeral and preferably both.

The method may further comprise reading the background colors from left to right to verify the diameter of the identified bolt and reading the colors of the at least one first other section taken alone or in combination with the at least one second other section to identify the length of the bolt depending on the measurement system used, either imperial or metric.

The method preferably further comprises attaching the identification labels on the containers of their corresponding bolts and on their corresponding structures associated with the corresponding bolts on each worksite. Marking the structures with identification labels on the worksite allows the operators to more easily remotely identify the needed bolts for these structures.

Understandably, the identification labels 300 or 400 may have any geometrical form once providing the needed identification sections. Preferably, the identification labels 300 or 400 may have a rectangular form.

In another preferred embodiment, the identification labels 300 or 400 may comprise a letter, such as G, to indicate a galvanized bolt.

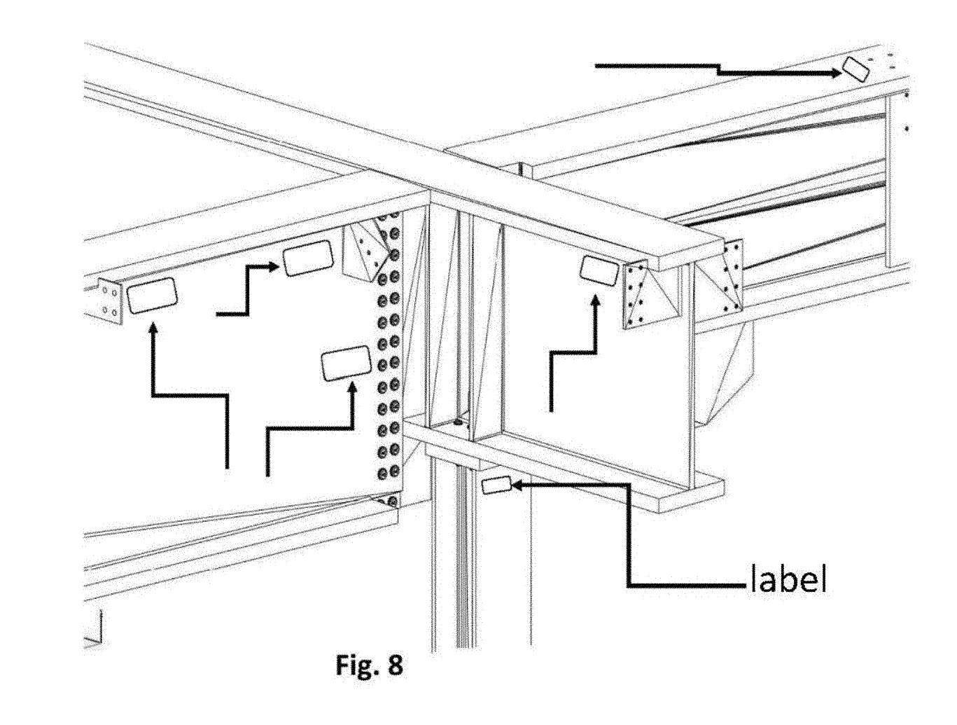

Referring to FIG. 8, an example of a structure on which are attached identification labels to show the type of bolts to be installed in an appropriate zone allowing a distance identification of the bolts.

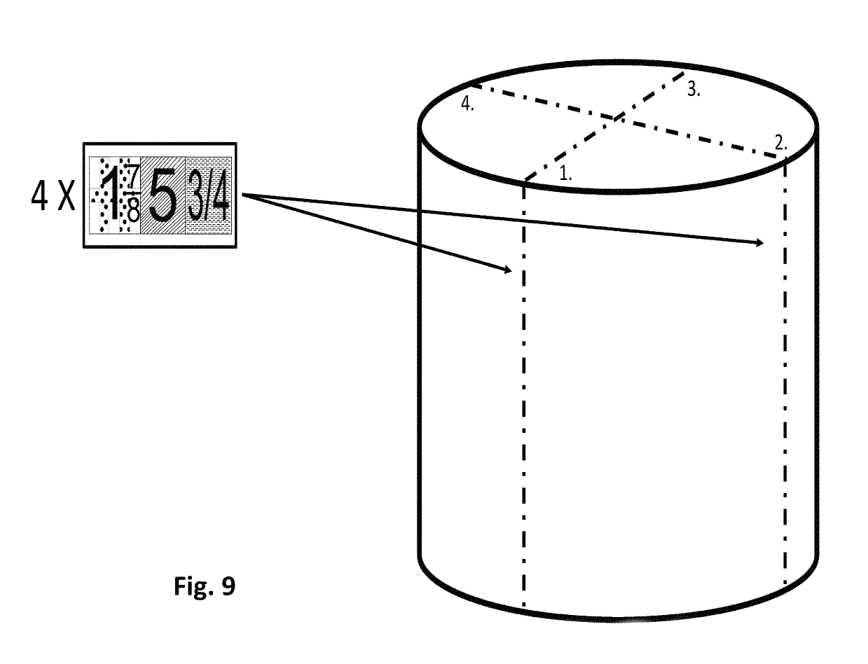

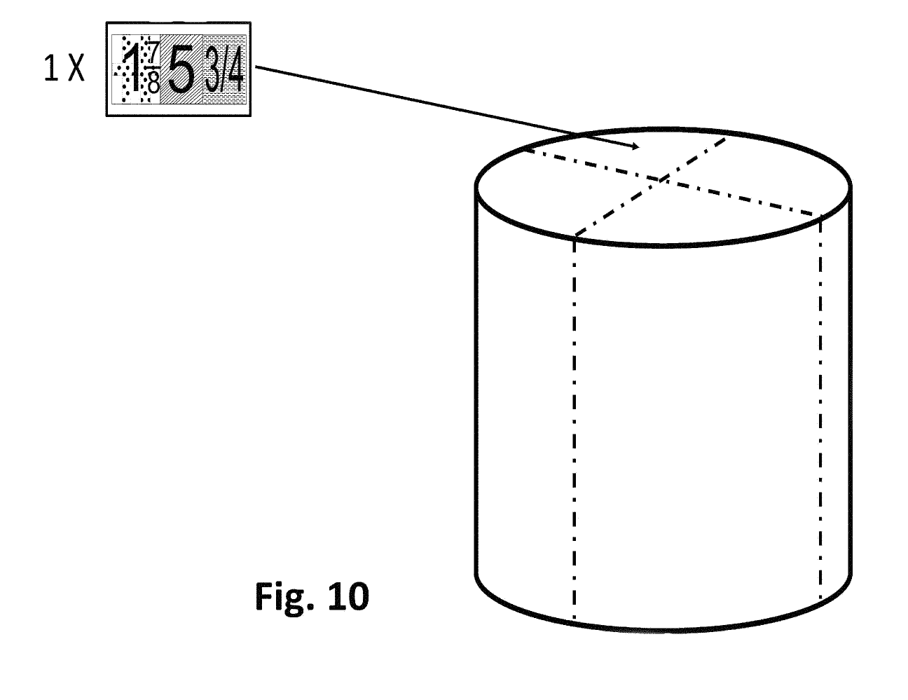

Referring to FIG. 9-10, an example of a circular container on which are attached identification labels on the body of the circular container at each 90 degree is illustrated on FIG. 9; an example of a circular container on which is attached an identification label on the top of the circular container is illustrated on FIG. 10.

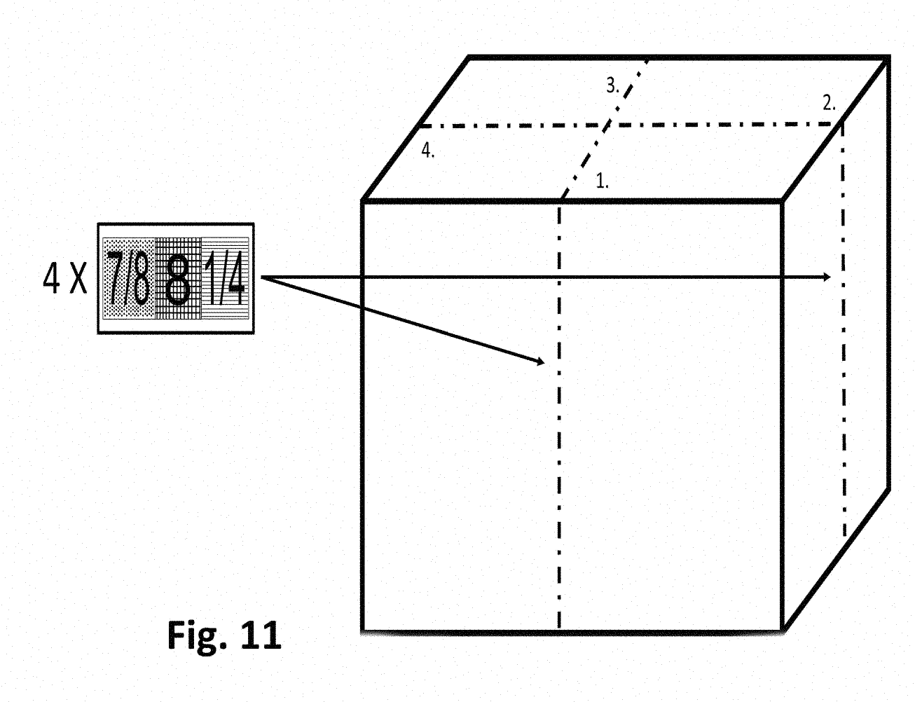

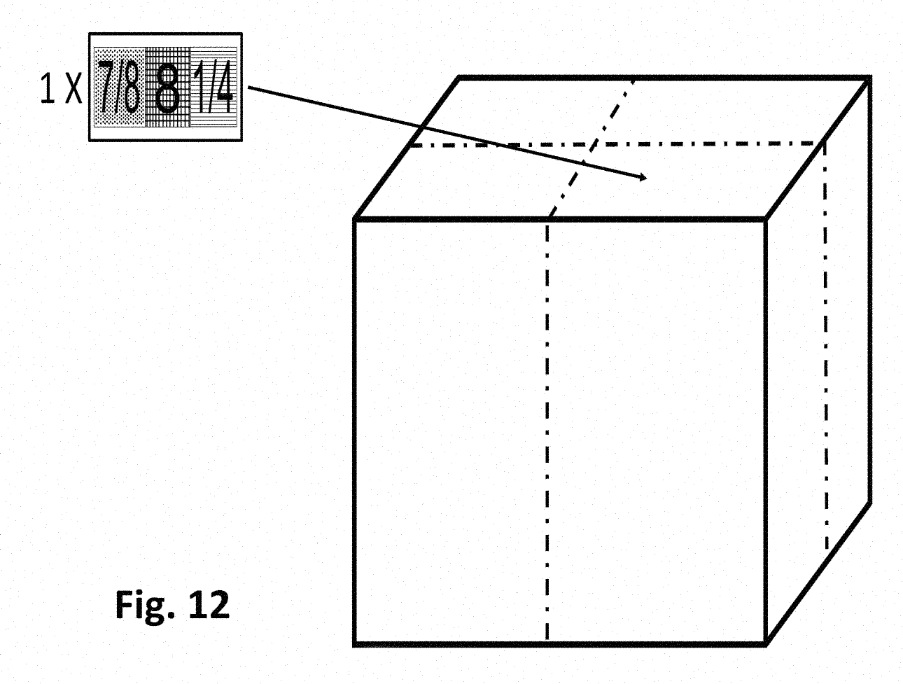

Referring to FIG. 11-12, an example of a box on which are attached identification labels on each lateral side of the box is illustrated on FIG. 11; an example of a box on which is attached an identification label on the top of the box is illustrated on FIG. 12.

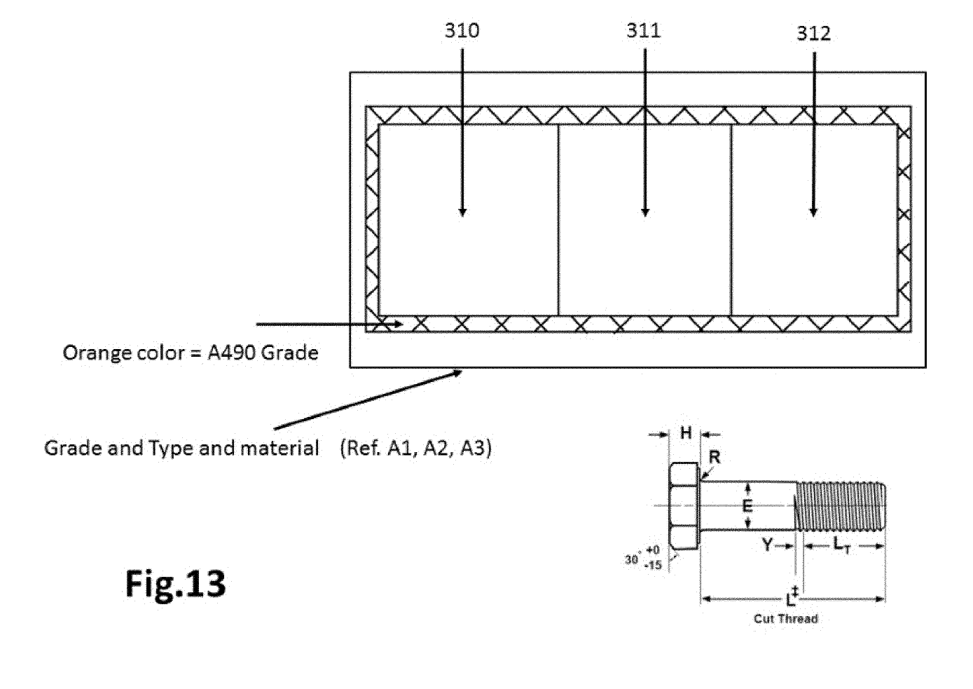

Referring to FIG. 13, another example of an identification label used with the imperial measurement system to identify bolts having a hexagonal head is illustrated. The section 310 on the left side indicates the diameter. The central section 311 and the right section 312 are used to specify the length of the bolt. In this case, the right section is shaped like a square to associate the label with a bolt having a hexagonal head.

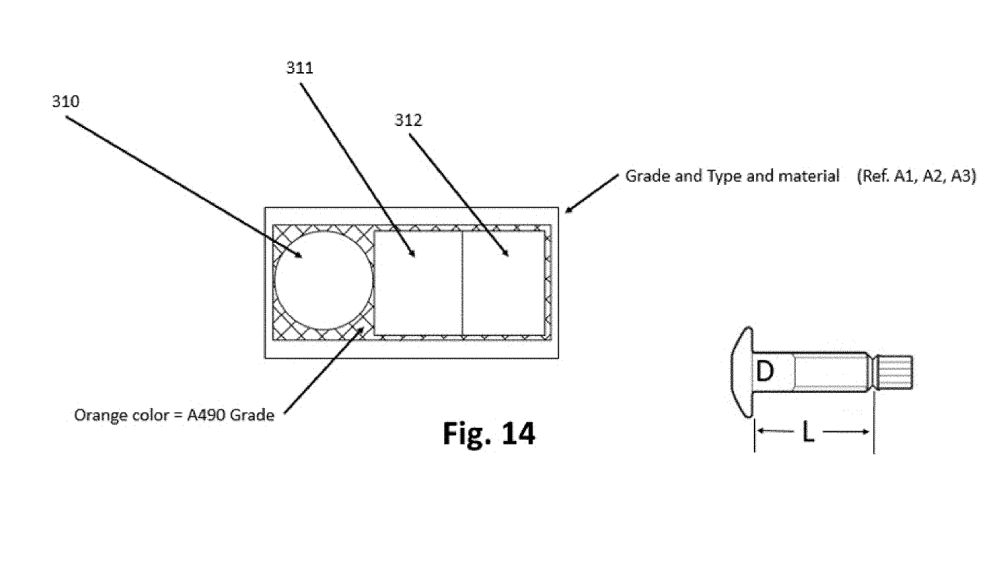

Referring to FIG. 14, another example of an identification label used with the imperial measurement system to identify bolts having a round head is illustrated. The section 310 on the left side indicates the diameter. The central section 311 and the right section 312 are used to specify the length of the bolt. In this case, the right section is shaped like a circle to associate the label with a bolt having a round head.

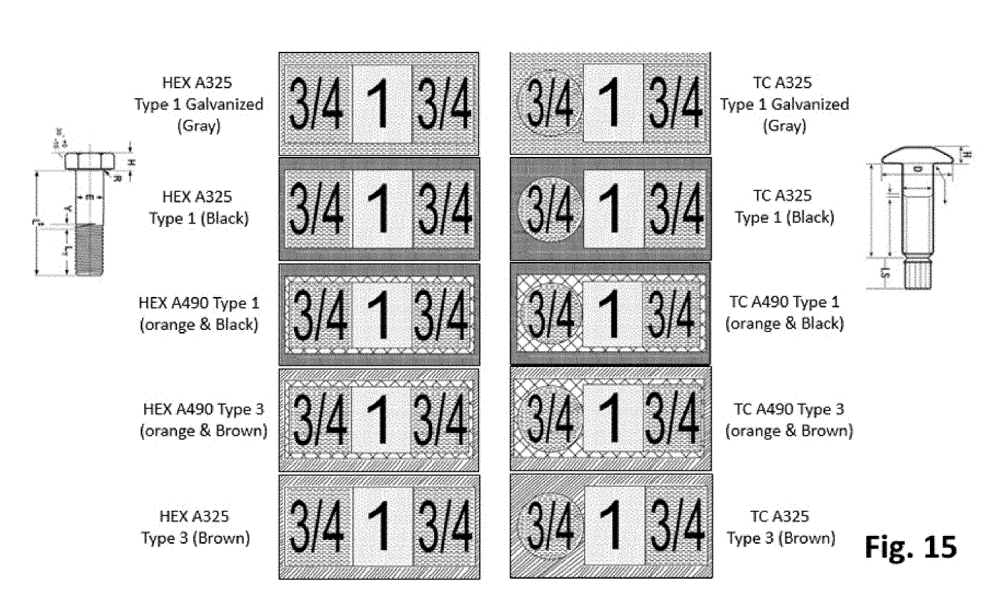

FIG. 15 shows various examples of bolts of different types. The central portion 511 indicates the numeral 1 and the right portion 512 the fraction ¾, which together thus together indicate a length of 1¾ inch. The square shape of the left portion of FIG. 15 is used in this instance to indicate a hexagonal head while the round shape of the left portion of FIG. 15 indicates a round head.

The colour of the rectangular contour can be used to indicate the type of metal the bold is made from. In this example, all gray means an A325 type 1 galvanized bolt, all black means an A325 type 1 bolt, all brown means an A325 type 3 bolt, half black and half orange means an A490 type 1 bolt and half brown and half orange means an A490 type 3 bolt.

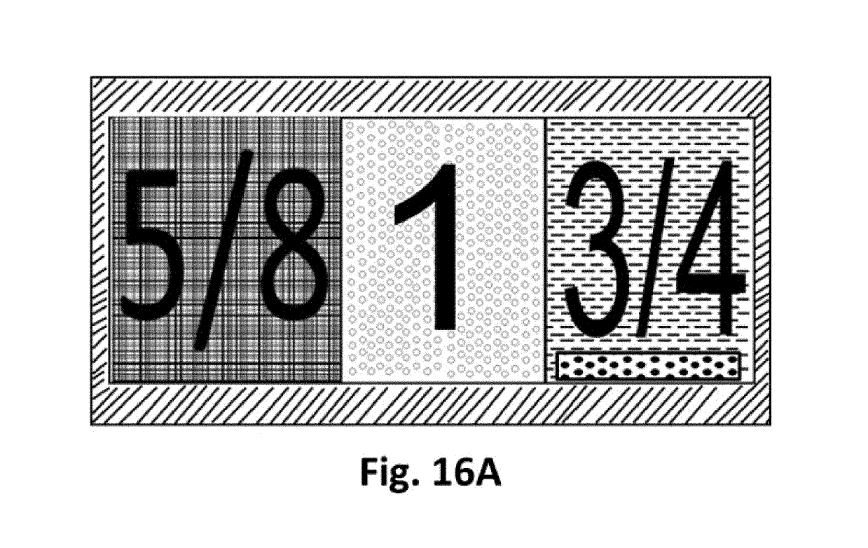

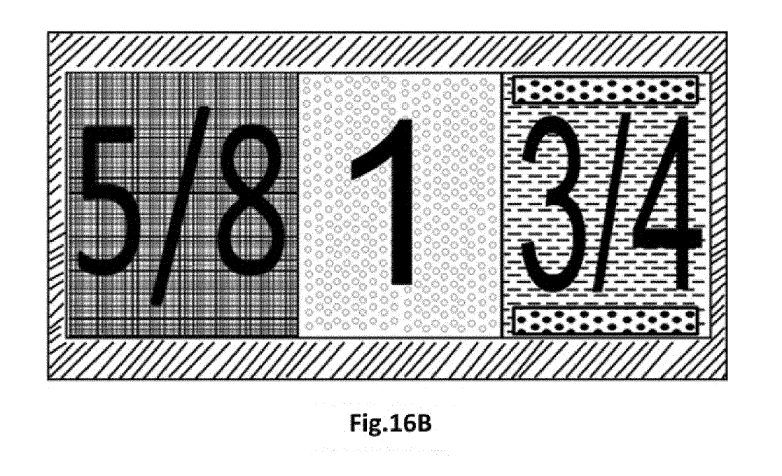

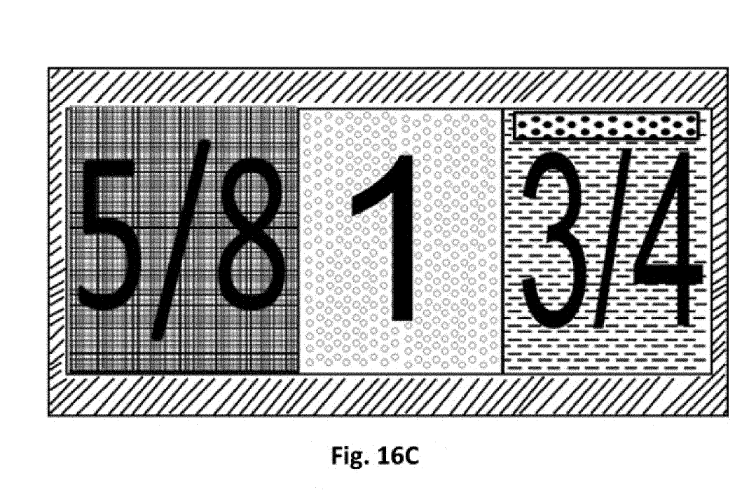

In FIGS. 16A, 16B and 16C, an additional and optional marking in the form of a rectangle over or under the numeral is added to the right portion to indicate the presence (or not) of a washer placed adjacent the free end (FIG. 16A), the head and the free end (FIG. 16B) or the head (FIG. 16B).

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

What is claimed is:

1. A system for sorting bolts, bars, pins, studs, dowels, or screws, collectively and individually described herein as a bolt, the bolts being characterized by a length and a diameter, wherein each length of said bolts is associated to a numeral and to a selected color and wherein each diameter of said bolts is associated to a numeral and to a selected color.

2. The system of claim 1 further comprising:
a. an identification label comprising:
i. a main section adapted to receive at least one color and a numeral which is associated with said length; and
ii. at least a first other section adapted to receive at least one color and a numeral which is associated with said diameter;
b. a chart to define the correspondence between the colors and numerals to a value of said length and said diameter.

3. The system of claim 2, wherein the identification label comprises at least a second other section adapted to receive at least one color and a numeral when the said length and diameter are identified using the imperial measurement system.

4. The system of claim 3, wherein each combination of a color and a numeral is pre-defined by said chart; wherein a combination of colors and numerals of the main section defines the length of the bolt; and wherein a combination of colors and numerals of the first other section and of the second other section define together the diameter of the bolt.

5. The system of claim 2, wherein the said labels are attached to containers containing the bolts and to structures on a worksite where the bolts are destined to be installed.

6. The system of claim 2, wherein the said label allows a distant identification of bolts required to be installed to a corresponding labeled structure on a worksite.

7. The system of claim 1, wherein the said label allows a distant identification of the containers in which the bolts are stored.

8. The system of claim 1, wherein the identification label further comprises a further symbol indicating the type of bolt.

9. The system of claim 1, wherein the identification label further comprises a further symbol indicating the presence and location or absence of a washer.

10. An identification label for identifying bolts, bars, pins, studs, dowels, or screws, collectively and individually described herein as a bolt, the bolts being characterized by a length and a diameter, the identification label comprising:
a. a main section adapted to receive at least one color and a numeral associated to said length; and
b. at least a first other section adapted to receive at least one color and a numeral associated to said diameter.

11. The identification label of claim 9, further comprising at least a second other section adapted to receive at least one color and a numeral when said length and diameter use the imperial measurement system.

12. The identification label of claim 11, wherein each combination of a color and a numeral is defined by said color chart; wherein a combination of colors and numerals of the main section defines the length of the bolt; and wherein a combination of colors and numerals of the at least first and second other sections defines together the diameter of the bolt.

13. The identification label of claim 9, being attached to the bolts containers and/or to structures on worksite to which said bolts are to be installed.

14. The identification label of claim 13, wherein the said label allows a distant identification of the bolts required to be installed to a corresponding labeled structure on a worksite.

15. The identification label of claim 13, wherein the said label allows a distant identification of containers containing the bolts.

16. The identification label of claim 9, further comprises a symbol indicating a type of bolt.

17. The identification label of claim 9, wherein the identification label further comprises a further symbol indicating the presence and location or absence of a washer.

18. A method for identifying and sorting bolts, bars, pins, studs, dowels or screws, collectively and individually described herein as a bolt having a length and a diameter, the method comprising:
a. creating a chart wherein each length of said bolts is associated to a numeral and to a selected color and wherein each diameter of said bolts is associated to a numeral and to a selected color;
b. providing an identification label comprising a main section and at least a first other section;
c. associating the main section with said length and with at least one of said associated color and one said associated numeral; and
d. associating the at least first other section with said diameter and with at least one said color and one said numeral;
wherein each combination of a color and a numeral is selected from the color chart.

19. The method of claim 17, wherein the color and numeral associated with said main section corresponds to the length of the bolt.

20. The method of claim 19, wherein the color and numeral associated with said first other section corresponds to the diameter of the bolt.

21. The method of claim 17, wherein the imperial measurement system is used, the label further comprising a second other section, wherein the combination of colors and numerals associated with first other section and the second other section together correspond to the second dimension of the bolt and the method further comprising:
a. reading from left to right the colors and numerals of the main section to verify the length of the bolt;
b. reading from left to right the colors and numerals of the at least one first other section taken alone or in combination with the at least one second section to verify the diameter of the bolt depending on using either the imperial measurement system or the metric measurement system.

22. The method of claim 17, further comprises:
a. attaching at least one of said identification labels to a container of corresponding bolts and another of said identification labels to a corresponding structure where the bolts are destined to be installed on a worksite allowing a distant identification of the bolts;
b. attaching one of said identification labels on one side of the container and at another said identification label near the top of the container.
